(19) United States
(12) Patent Application Publication
(10) Pub. No.: US 2024/0413893 A1
(43) Pub. Date: Dec. 12, 2024

(54) COMMUNICATION SATELLITE SYSTEM, EDGE COMPUTING SYSTEM, AND MAIN SATELLITE

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 18/699,375

(22) PCT Filed: Oct. 13, 2021
(86) PCT No.: PCT/JP2021/037803

§ 371 Date: Apr. 8, 2024

(51) Int. Cl. H04B 7/185; H04B 10/118

(52) U.S. Cl. CPC H04B 7/18521; H04B 10/118

(57) ABSTRACT

A communication satellite system includes orbit planes with azimuth components of normal vectors distributed to a longitudinal direction. Each orbit plane is taken as a target orbit plane corresponding to an inclined orbit, and satellites are flying on the target orbit plane. A target satellite on the target orbit plane includes a first communication device to communicate with satellites where the target satellite is flying and positioned at front and rear with respect to a traveling direction of the target satellite, a second communication device to communicate with a ground installation, and a third communication device to communicate with a satellite flying on another orbit plane. On the target orbit plane, the plurality of satellites flying on the target orbit plane form a circular communication network.

### TECHNICAL FIELD

The present disclosure relates to communication satellite systems, edge computing systems, and main satellites.

### BACKGROUND ART

In communication using GEO (Geostationary Earth Orbit) satellites, latency associated with long-distance communication poses a problem. To address this, in recent years, development of a communication satellite system by a megaconstellation formed of an LEO (Low Earth Orbit) satellite group has been advancing. However, in the communication satellite system under present circumstances, while individual satellites communicate by the bent-pipe scheme, intersatellite communication is not performed. Thus, addition of an intersatellite communication function in the communication satellite system has been awaited.

### CITATION LIST

### Patent Literature

Patent Literature 1: U.S. Pat. No. 9,647,749 B2

### SUMMARY OF INVENTION

### Technical Problem

Patent Literature 1 discloses a communication satellite system by an LEO constellation formed of an LEO satellite group for performing optical intersatellite communication with satellites positioned at front, rear, left, and right. However, according to the communication satellite system, a lateral change in position of orbits occurs at the south end and the north end of the orbit plane, thereby posing a problem in which communication interruption occurs twice for each orbiting in communication with satellites flying in adjacent orbits and positioned left and right. Also, with the above-described problem, a circuit is established by optical wireless communication twice for each orbiting, thereby posing a problem in which it is required to establish highly-accurate optical-axis alignment technology. A further problem is a large loss time.

The present disclosure has an object of preventing each satellite in a communication satellite system by an LEO constellation from always communicating with satellites flying in adjacent orbits and positioned at left and right.

### Solution to Problem

A communication satellite system according to the present disclosure is formed of a plurality of orbit planes, wherein
azimuth components of normal vectors with respect to each orbit plane of the plurality of orbit planes are distributed to a longitudinal direction,
each orbit plane of the plurality of orbit planes is taken as a target orbit plane, the target orbit plane is an orbit plane corresponding to an inclined orbit, and a plurality of satellites are flying on the target orbit plane,
each satellite flying on the target orbit plane is taken as a target satellite, and the target satellite includes a first communication device to communicate with satellites flying on an orbit plane where the target satellite is flying and positioned at front and rear with respect to a traveling direction of the target satellite, a second communication device to communicate with a ground installation set on ground, and a third communication device to communicate, in proximity to a point of intersection formed in plan view by the orbit plane where the target satellite is flying and another orbit plane, which is an orbit plane different from the orbit plane where the target satellite is flying, with a satellite flying on the another orbit plane, and
on the target orbit plane, the plurality of satellites flying on the target orbit plane form a circular communication network.

### Advantageous Effects of Invention

The communication satellite system according to the present disclosure may be one by an LEO constellation. Also, in the present disclosure, a satellite flying on a target orbit plane and a satellite flying on another orbit plane communicate with each other in proximity to a point of intersection formed in plan view by the target orbit plane and the another orbit plane. Therefore, according to the present disclosure, each satellite in the communication satellite system by the LEO constellation does not always communicate with satellites flying in adjacent orbits and positioned at left and right.

### BRIEF DESCRIPTION OF DRAWINGS

FIG. 1 is a diagram schematically illustrating a communication satellite system 10 according to Embodiment 1.

FIG. 2 is a diagram for describing a circular communication network according to Embodiment 1.

FIG. 3 is a diagram illustrating an example of hardware configuration of a satellite 30 according to Embodiment 1.

FIG. 4 is a diagram illustrating an example of hardware configuration of a ground installation 90 according to Embodiment 1.

FIG. 5 is a diagram for describing an operation example of the communication satellite system 10 according to Embodiment 1.

FIG. 6 is a diagram illustrating a state in which a circular communication network is formed.

FIG. 7 is a diagram illustrating a state in which communication is performed with satellites positioned at front, rear, left, and right.

FIG. 8 is a diagram for describing a lateral change in position of satellites.

FIG. 9 is a diagram for describing interorbital communication according to Embodiment 1.

FIG. 10 is a diagram for describing interorbital communication according to Embodiment 1.

FIG. 11 is a diagram illustrating a state in which the Earth's rotation and rotation of the orbit plane of an inclined-orbit satellite do not synchronize with each other, in which (a) is a specific example of a state at 06:00 and (b) is a specific example of a state at 12:00.

FIG. 12 is a diagram illustrating an example of hardware configuration of the ground installation 90 according to a modification of Embodiment 1.

FIG. 13 is a diagram illustrating a configuration example of an edge computing system 11 according to Embodiment 2.

FIG. 14 is a diagram for describing an operation example of the edge computing system 11 according to Embodiment 2.

### DESCRIPTION OF EMBODIMENTS

In the description of embodiments and the drawings, identical components and corresponding components are provided with identical reference numerals. The description of the components provided with identical reference numerals is omitted or simplified as appropriate. Arrows in the drawings mainly indicate flows of data or flows of processing. Also, “unit” may be read as “circuit”, “step”, “procedure”, “process”, or “circuitry” as appropriate. In the specification, an artificial satellite may be denoted simply as a satellite.

Further, in the description of the embodiments, directions or positions such as “upper”, “lower”, “left”, “right”, “fore”, “rear”, “front”, or “back” may be designated. Those expressions are given only for convenience of description and do not restrict placement and orientations of configurations such as devices, instruments, or components.

### Embodiment 1

Hereinbelow, the present embodiment will be described in detail with reference to the drawings.

### Description of Configuration

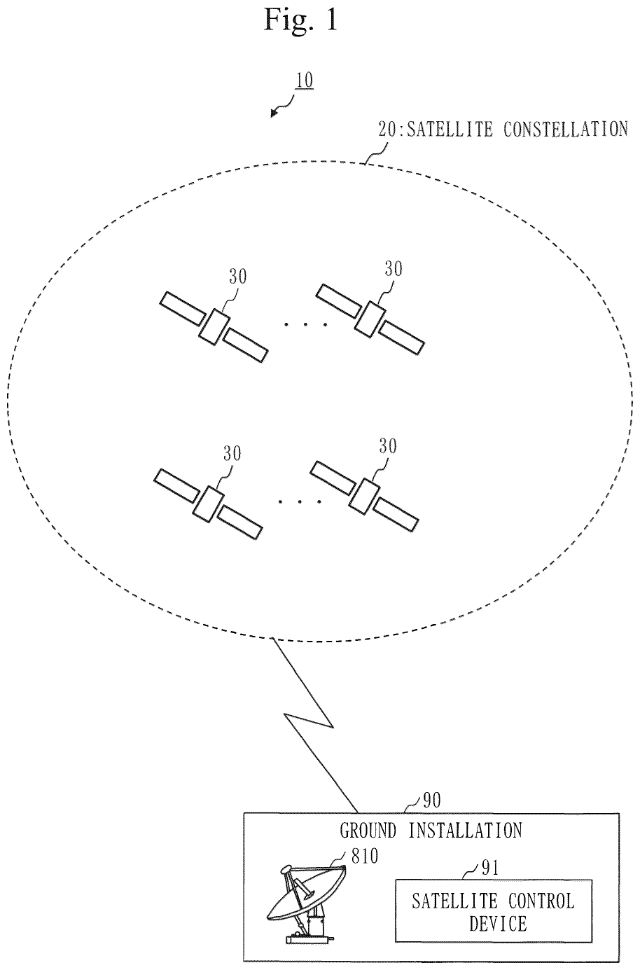

FIG. 1 schematically illustrates a communication satellite system 10 according to the present embodiment.

The communication satellite system 10 includes, as illustrated in the drawing, a satellite constellation 20 and a ground installation 90.

The satellite constellation 20 is formed of a plurality of orbit planes and, typically, is an inclined-orbit satellite constellation in which the orbit of each satellite 30 is an inclined orbit. That is, the communication satellite system 10 is formed of a plurality of orbit planes. The satellite constellation 20 may be an LEO (Low Earth Orbit) constellation. Also, azimuth components of a normal vector with respect to each orbit plane of the plurality of orbit planes are distributed to a longitudinal direction. When each orbit plane of the plurality of orbit planes is taken as a target orbit plane, the target orbit plane is an orbit plane corresponding to an inclined orbit, and a plurality of satellites 30 are flying on the target orbit plane. Also, when each satellite 30 flying on the target orbit plane is taken as a target satellite, the target satellite includes a first communication device, a second communication device, and a third communication device. The first communication device communicates with the satellites 30 flying on an orbit plane where the target satellite is flying and positioned at front and rear with respect to a traveling direction of the target satellite. The second communication device communicates with the ground installation 90 set on the ground. The third communication device communicates, in proximity to a point of intersection formed in plan view by the orbit plane where the target satellite is flying and another orbit plane, which is an orbit plane different from the orbit plane where the target satellite is flying, with the satellite 30 flying on the other orbit plane. At least two of the first communication device, the second communication device, and the third communication device may be integrally configured as appropriate. Note that the proximity to the point of intersection is an area including and surrounding the point of intersection. The range of the proximity to the point of intersection may be defined as appropriate.

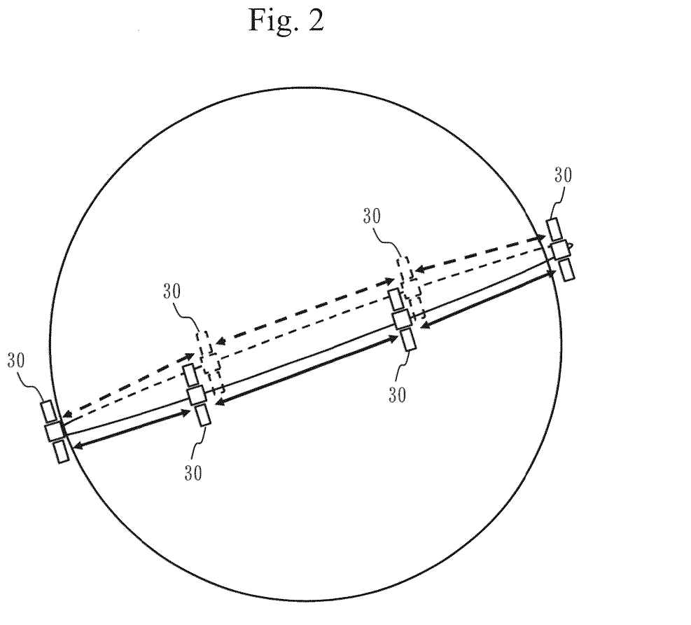

Also, on the target orbit plane, the plurality of satellites 30 flying on the target orbit plane form a circular communication network. FIG. 2 is a diagram for describing the circular communication network formed by the plurality of satellites 30. As illustrated in FIG. 2, with the satellites 30 adjacent in the same orbit communicating with each other, a circular communication network is formed on each orbit plane of the plurality of orbit planes.

Specific examples of the satellite constellation 20 are disclosed in [Reference Literature 1] and [Reference Literature 2]. The communication satellite system 10 includes functions disclosed in these reference literatures as appropriate. Also, the satellite constellation 20 may be a megaconstellation.

### Reference Literature 1

JP 2021-054167 A

### Reference Literature 2

JP 2021-070342 A

The ground installation 90 includes a ground-side communication device 810 and a satellite control device 91, and communicates with each satellite 30, thereby controlling the satellite constellation 20.

The satellite control device 91 is a computer that generates various commands for controlling each satellite 30, and includes hardware such as a processing circuit and an input-output interface. The processing circuit generates various commands. To the input-output interface, an input device and an output device are connected. The satellite control device 91 is connected via the input-output interface to the ground-side communication device 810.

The ground-side communication device 810 communicates with each satellite 30. Specifically, the ground-side communication device 810 transmits various commands to each satellite 30.

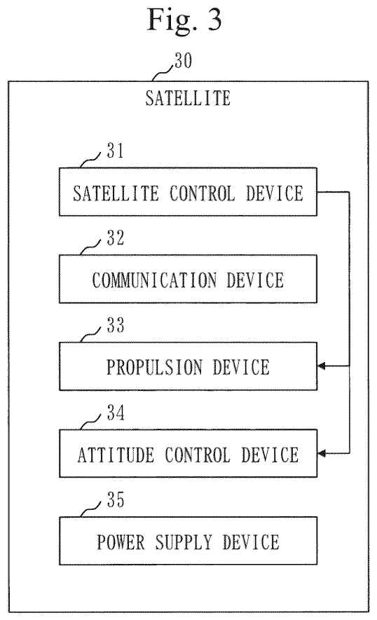

FIG. 3 illustrates an example of hardware configuration of the satellite 30. With reference to FIG. 3, the hardware configuration of the satellite 30 is described.

The satellite 30 includes a satellite control device 31, a communication device 32, a propulsion device 33, an attitude control device 34, and a power supply device 35. While the satellite 30 may include a component achieving other various functions, description is made in FIG. 3 on the satellite control device 31, the communication device 32, the propulsion device 33, the attitude control device 34, and the power supply device 35.

The satellite control device 31 is a computer to control the propulsion device 33 and the attitude control device 34 and includes a processing circuit. Specifically, the satellite control device 31 controls the propulsion device 33 and the attitude control device 34 in accordance with various commands transmitted from the ground installation 90 and so forth.

The communication device 32 is a device to perform communication outside the satellite 30. The communication device 32 is also a general term of a first communication device, a second communication device, and a third communication device.

The propulsion device 33 is a device to give a propulsive force to the satellite 30 and changes the speed of the satellite 30.

The attitude control device 34 is a device to control attitude elements such as an attitude of the satellite 30, an angular speed of the satellite 30, and a line of sight. The attitude control device 34 changes the attitude elements in desired directions. Alternatively, the attitude control device 34 maintains the attitude elements in desired directions. The attitude control device 34 includes an attitude sensor, an actuator, and a controller. The attitude sensor is such a device as a gyroscope, an earth sensor, a sun sensor, a star tracker, a thruster, and a magnetic sensor. The actuator is such a device as an attitude control thruster, a momentum wheel, a reaction wheel, and a control moment gyro. The controller controls the actuator in accordance with measured data from the attitude sensor or various commands from the ground installation 90 and so forth.

The power supply device 35 includes equipment such as a solar cell, a battery, and a power controller and supplies power to each equipment mounted in the satellite 30.

The processing circuit included in the satellite control device 31 is described. The processing circuit may be dedicated hardware or may be a processor to execute a program stored in a memory. In the processing circuit, some functions may be fulfilled by dedicated hardware and the remaining functions may be fulfilled by software or firmware. That is, the processing circuit may be implemented by hardware, software, firmware, or a combination of those. Specifically, the dedicated hardware is a single circuit, a composite circuit, a programmed processor, a parallelly programmed processor, an ASIC, an FPGA, or a combination of those. ASIC is an abbreviation of Application Specific Integrated Circuit. FPGA is an abbreviation of Field Programmable Gate Array.

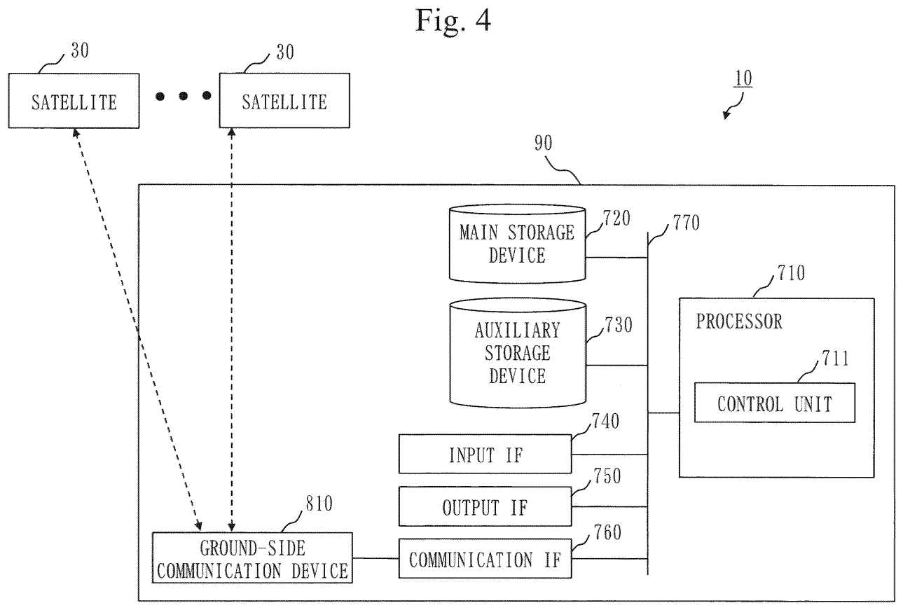

FIG. 4 illustrates an example of hardware configuration of the ground installation 90. The ground installation 90 communicates with the satellites 30. The ground installation 90 is connected to the ground-side communication device 810, and the ground installation 90 communicates with the satellites 30 via the ground-side communication device 810. The ground installation 90 may be a mobile terminal.

The ground installation 90 includes a processor 710 and further includes other pieces of hardware such as a main storage device 720, an auxiliary storage device 730, an input interface 740, an output interface 750, and a communication interface 760. In FIG. 4, each interface is denoted as IF. The processor 710 is connected via a signal line 770 to other pieces of hardware to control the other pieces of hardware.

The ground installation 90 includes, as a functional element, a control unit 711. The functions of the control unit 711 are achieved by hardware or software. The control unit 711 performs processing by following an instruction from a communication satellite program.

### Description of Operation

The operation procedure of the communication satellite system 10 corresponds to a communication satellite method. Also, a program for achieving the operation of the communication satellite system 10 corresponds to a communication satellite program. The communication satellite program is a general term of programs operating in each device included in the communication satellite system 10. The communication satellite program may be recorded on a computer-readable, non-volatile recording medium. The non-volatile recording medium is, as a specific example, an optical disk or flash memory. The communication satellite program may be provided as a program product.

### Operation Example 1 According to Embodiment 1

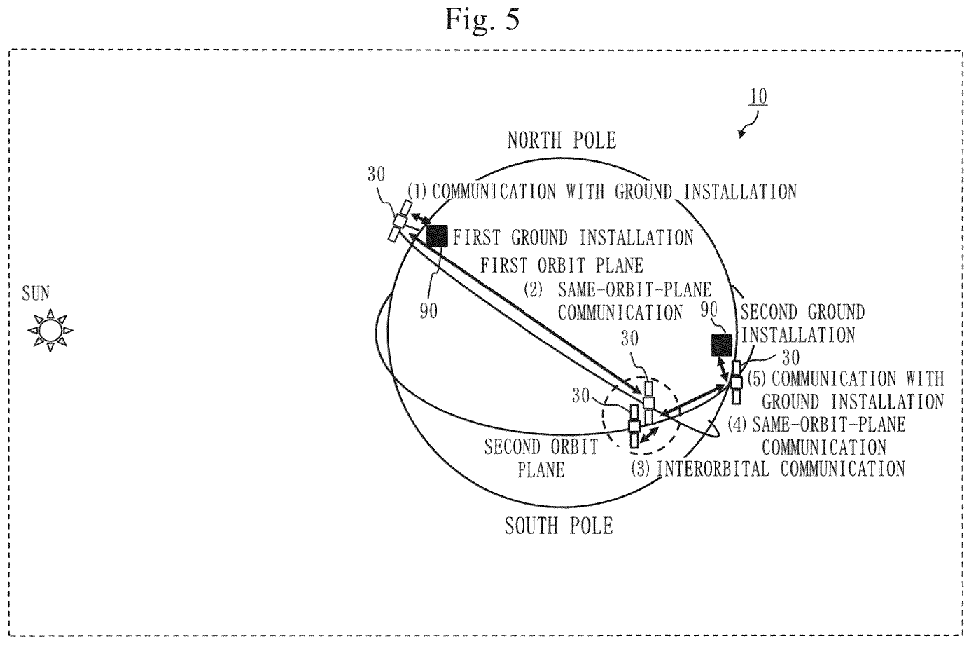

FIG. 5 is a diagram for describing the present operation example. The present operation example is described with reference to FIG. 5.

(1) Communication with the Ground Installation

A first receiving satellite, which is the satellite 30 flying on a first orbit plane, receives communication data, which is data transmitted by a first ground installation 90, over the first ground installation 90. The first orbit plane is an orbit plane passing over the first ground installation 90, and any of orbit planes configuring a plurality of orbit planes. Note that an area over the ground installation 90 is an area where the satellites 30 can communicate with the ground installation 90.

### (2) Same-Orbit-Plane Communication

The first receiving satellite shares the communication data with another satellite 30 flying on the first orbit plane via a circular communication network formed on the first orbit plane.

### (3) Interorbital Communication

In proximity to a point of intersection formed in plan view by the first orbit plane and a second orbit plane, any satellite 30 of the plurality of satellites 30 flying on the first orbit plane transmits the communication data to a second receiving satellite, which is the satellite 30 flying on the second orbit plane. The second orbit plane is an orbit plane passing over a second ground installation 90, and any of orbit planes configuring a plurality of orbit planes except the first orbit plane.

### (4) Same-Orbit-Plane Communication

The second receiving satellite shares the communication data with another satellite 30 flying on the second orbit plane via a circular communication network formed on the second orbit plane.

(5) Communication with the Ground Installation

Any satellite 30 of the plurality of satellites 30 flying on the second orbit plane transmits the communication data to the second ground installation 90 over the second ground installation 90.

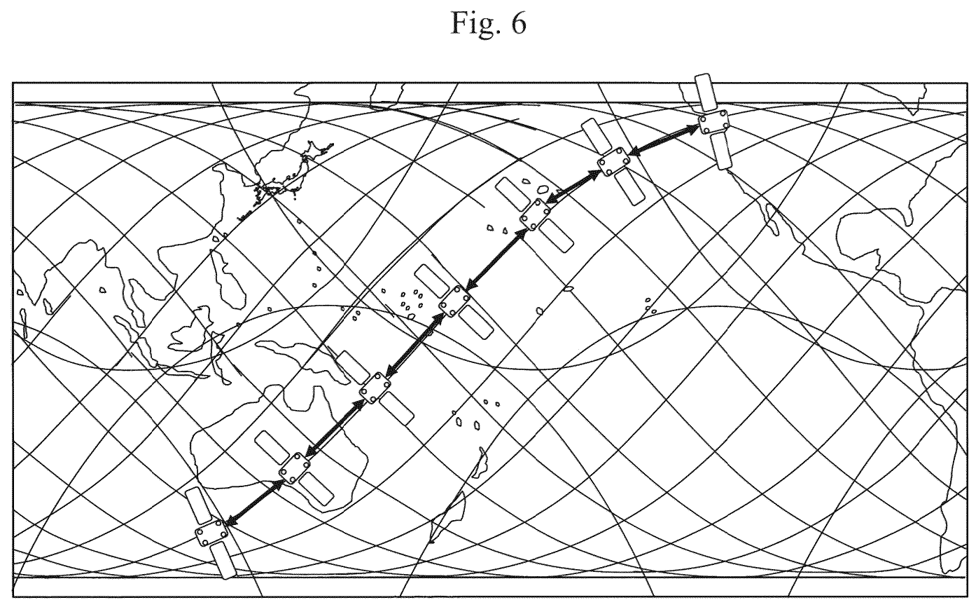

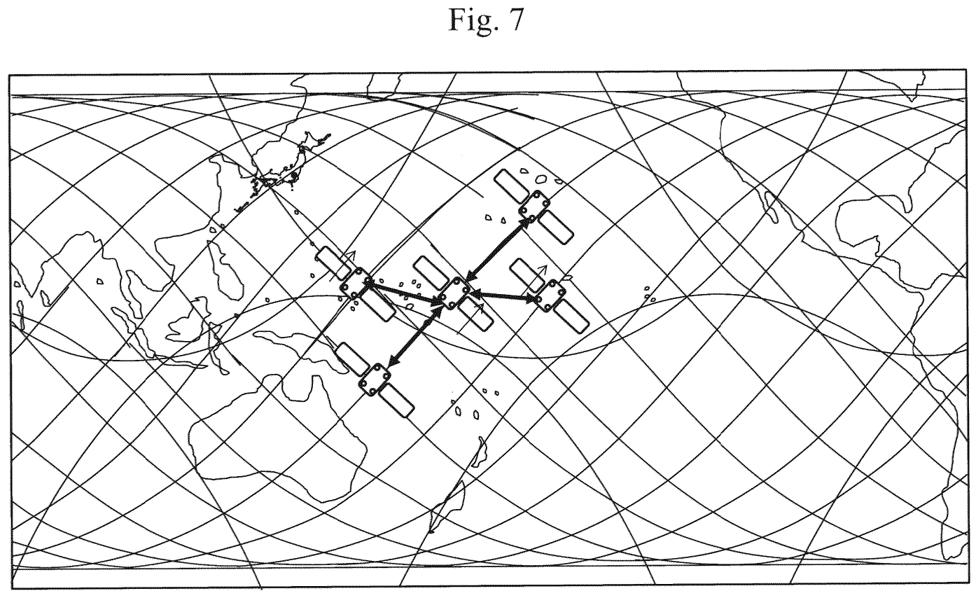

In recent years, plans are increasing to construct a communication satellite network by a large-scale satellite group called a megaconstellation. In the megaconstellation, by way of example, with each satellite communicating with front and rear satellites on each orbit plane, a circular communication network is formed and, furthermore, each satellite on each orbit plane communicates with satellites on an orbit plane adjacent to each orbit plane, the satellites being positioned at left and right of each satellite on each orbit plane. As a result, a mesh communication network is constructed, in which each satellite communicates with a total of four satellites positioned at front, rear, left, and right. FIG. 6 illustrates a state in which the circular communication network is formed. FIG. 7 illustrates a state in which a satellite communicates with a total of four satellites positioned at front, rear, left, and right.

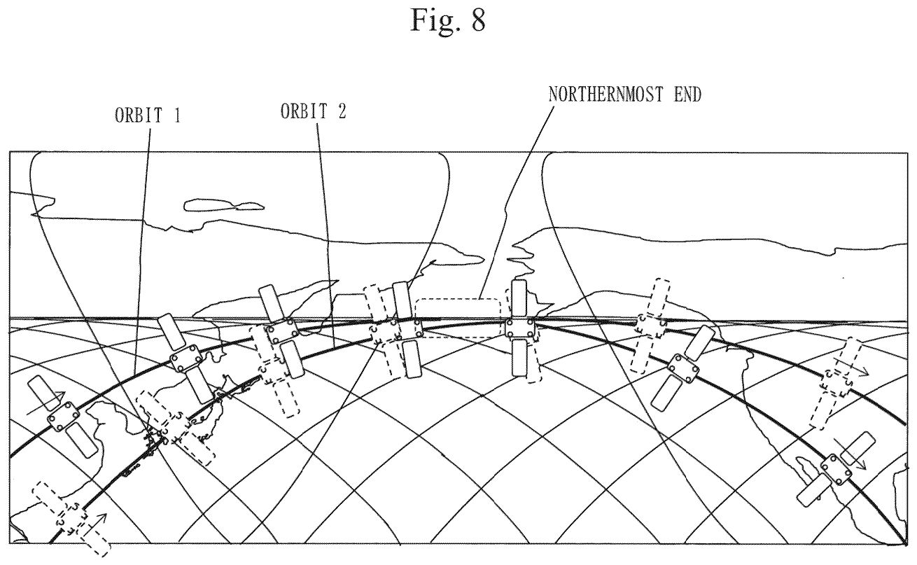

However, to maintain a communication state in communication with an adjacent orbit, directional control of the communication device is required. Also, a lateral change in position of orbits occurs at each of the northernmost end and the southernmost end of the orbit plane, thereby posing a problem in which it is difficult to continue one communication. FIG. 8 illustrates a state in which a lateral change in position occurs at the northernmost end of the orbit plane. In FIG. 8, on a right side of a traveling direction of a satellite flying in an orbit 1 until it reaches the northernmost end, a satellite flying in an orbit 2 is positioned. On the other hand, on a left side of the traveling direction of the satellite flying in the orbit 1 after reaching the northernmost end, the satellite flying in the orbit 2 is positioned.

In an inclined-orbit satellite constellation, there are two points of intersection of two orbit planes with different normal vectors. Thus, between the satellite 30 flying on one orbit plane and the satellite 30 flying on another orbit plane having a normal vector different from a normal vector the one orbit plane has, if satellite information is communicated via interorbital communication at a time point when the satellite 30 flying on the one orbit plane and the satellite 30 flying on the other orbit plane both pass the proximity to any of the points of intersection formed in plan view by the one orbit plane and the other orbit plane, the satellite information on both of the one orbit plane and the other orbit plane can be shared between both satellites 30. Similarly, each satellite 30 can share satellite information on all orbit planes.

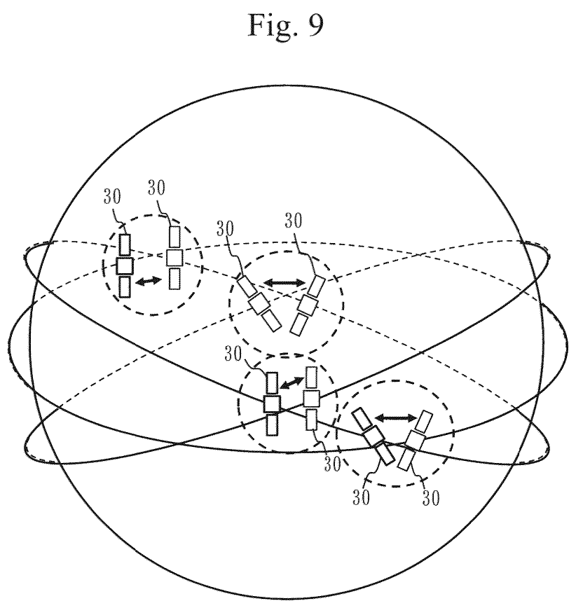

FIG. 9 is a diagram for describing interorbital communication, illustrating a specific example in which the satellite 30 flying on one orbit plane communicates with the satellites 30 flying on all of the other orbit planes.

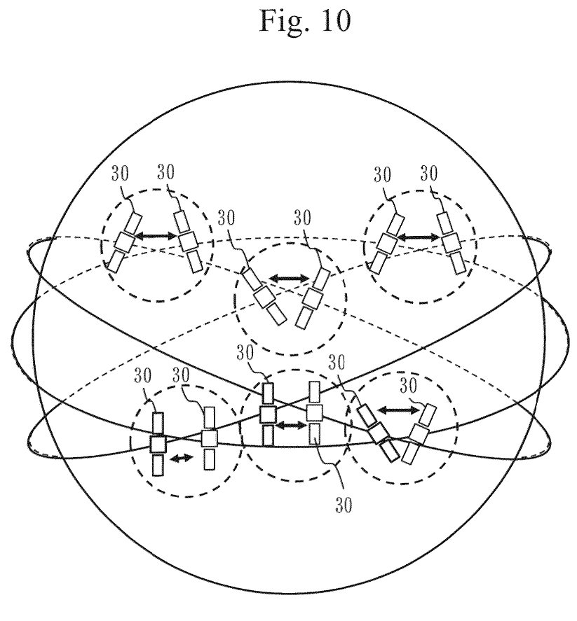

FIG. 10 is a diagram for describing interorbital communication, illustrating a specific example in which the satellite 30 flying on each orbit plane communicates with the satellites 30 flying on two other orbit planes.

Intersatellite communication to be performed when the satellite 30 passes the proximity to a point of intersection of orbit planes is not long-distance communication such as adjacent interorbital communication but is proximity communication. Thus, as a specific example, this intersatellite communication can be achieved by a simple communication device with a nondirectional antenna or fixed antenna.

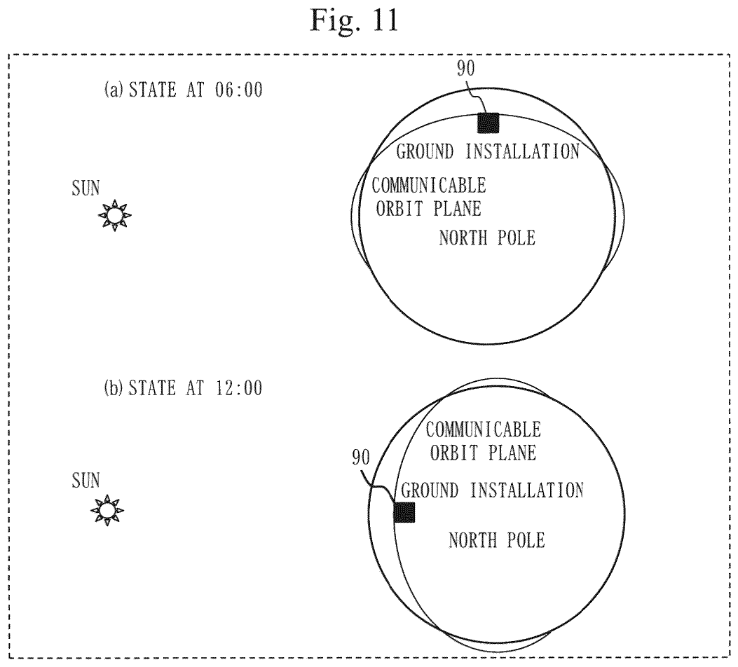

Also, there are many combinations of points of intersection where communication necessary for sharing satellite information of all orbit planes should be performed. Thus, each satellite 30 is not required to perform proximity communication at all points of intersection of inclined orbits, and is only required to perform proximity communication only in the proximity to each point of intersection belonging to a combination of rationally selected points of intersection. As a specific example, consider a case in which a first ground installation 90 communicates via the communication satellite system 10 with a second ground installation 90. In this case, the Earth's rotation and rotation of the orbit plane of an inclined-orbit satellite do not synchronize with each other. Thus, the orbit plane to which the satellite 30 flying over the first ground installation 90 belongs at a time TO is limited. FIG. 11 illustrates a state in which the Earth's rotation and the rotation of the orbit plane of the inclined-orbit satellite do not synchronize with each other. In FIG. 11, (a) illustrates a specific example of a state at 06:00, and (b) illustrates a specific example of a state at 12:00. In FIG. 11, a communicable orbit plane, which is an orbit plane where the satellite 30 communicable with the ground installation 90 flies, is not necessarily the same between 06:00 and 12:00.

Here, an orbit plane flying over the first ground installation 90 at the time TO is referred to as a first orbit plane. Also, an orbit plane flying over the second ground installation 90 at the time TO is referred to as a second orbit plane. When the first orbit plane and the second orbit plane are the same, communication can be made between the first ground installation 90 and the second ground installation 90 via a circular communication network. On the other hand, when the first orbit plane and the second orbit plane are different, it is required to connect a first circular communication network formed by the first orbit plane and a second circular communication network formed by the second orbit plane together. To do this, by the satellites 30 passing in proximity to any point of intersection formed in plan view by the first orbit plane and the second orbit plane communicating with each other, the first circular communication network and the second circular communication network can be connected together.

Note that when the orbit altitude of the first orbit plane and the orbit altitude of the second orbit plane are the same, a point of intersection of the first orbit plane and the second orbit plane is present. Thus, it is only required that, in proximity to any point of intersection formed by the first orbit plane and the second orbit plane, communication is made between the satellite 30 belonging to the first orbit plane and the satellite 30 belonging to the second orbit plane. Meanwhile, in a case in which, for example, each of the orbit of the first orbit plane and the orbit of the second orbit plane is an oval orbit with eccentricity, as a specific example, communication is performed between the satellite 30 belonging to the first orbit plane and the satellite 30 belonging to the second orbit plane in proximity to a closest approach point between the first orbit plane and the second orbit plane, not in proximity to a point of intersection of the first orbit plane and the second orbit plane. That is, a point of intersection formed in plan view by the first orbit plane and the second orbit plane may be, for example, the closest approach point between the first orbit plane and the second orbit plane, which is not a point where the first orbit plane and the second orbit plane actually cross.

Here, a LEO satellite passes over any ground installation for a short period of time. Also, the orbit of the LEO satellite is a sun-nonsynchronous orbit. That is, the rotation of the orbit plane of the LEO satellite does not synchronize with the Earth's rotation, and therefore the orbit plane where the LEO satellite passes over the ground installation changes momentarily. Thus, for communication from one ground installation to another ground installation by the conventional technology, it is required to make an operation plan by previously performing a search for an orbit plane passing over each of the one ground installation and the other ground installation, a search for a communication path, selection of a satellite to be passed through, and setting of times when each satellite on the communication path transmits and receives information. Therefore, according to the conventional technology, there is a problem in which operation of the communication satellite system is burdensome. Moreover, according to the conventional technology, there is a problem in which, at the ground installation, it is required to generate a communication command to a satellite based on the operation plan and transmit the generated communication command to the satellite in the orbit.

According to the present operation example, since the elongation of normal vectors the first orbit plane and the second orbit plane have in the longitudinal direction is known, the position of the point of intersection of the first orbit plane and the second orbit plane is also known. Therefore, according to the present operation example, when the first ground installation 90 communicates with the second ground installation 90 via the communication satellite system 10, by utilizing the known position of the point of intersection of the first orbit plane and the second orbit plane, it is not required to pass through many orbit planes. Thus, according to the present operation example, one effect is that communication between adjacent orbits can be achieved without complex communication route search. Also, according to the present operation example, one effect is that loads on the ground installation can be reduced.

### Operation Example 2 According to Embodiment 1

The present operation example corresponds to an operation example obtained by expanding the operation example 1 according to Embodiment 1. In the present operation example, the total number of orbit planes configuring the plurality of orbit planes is twelve or more, and the total number of satellites 30 flying on the respective orbit planes of the plurality of orbit planes is fifteen or more.

With the advent of ultrasonic glider bombs, it becomes impossible to cope with flying objects only by detecting a launch by a satellite in a geostationary orbit. To address this, a flying object tracking system by a low-earth-orbit satellite constellation has been awaited.

Monitoring directed to the edge of the Earth is also called limb monitoring, and flying objects can be monitored by limb monitoring, with the outer space as a background. Thus, one effect is that the flying object main body with its temperature increased after the end of a blast can be monitored by an infrared surveillance device without being buried in errors.

Flying object information obtained by the low-earth-orbit satellite is required to be quickly transmitted to a coping asset. Here, as a specific example, a communication satellite system that quickly transmits satellite information to the ground installation 90 arranged at 35 degrees north latitude and 140 degrees east longitude has been awaited.

According to the present operation example, one effect is that satellite information can be quickly transferred to the ground installation 90. Also, one effect is that a device for communication between orbit planes with different normal vectors can be achieved at relatively low cost.

### Other Configurations

### <Modification 1>

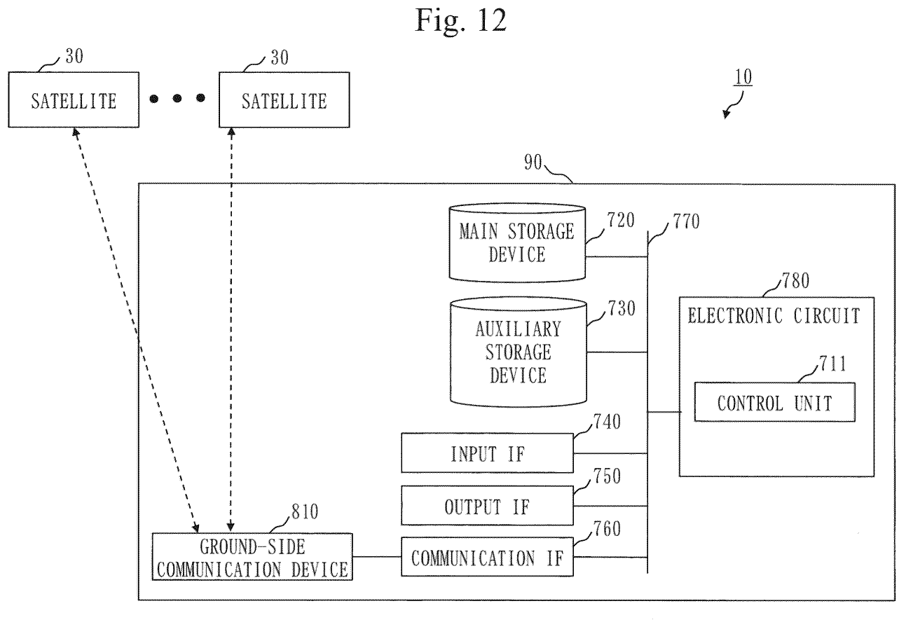

In the present embodiment, the functions of the control unit 711 are implemented by software. As a modification, the functions of the control unit 711 may be implemented by hardware. FIG. 12 illustrates the present modification.

The ground installation 90 includes an electronic circuit 780 in place of the processor 710.

The electronic circuit 780 is a dedicated electronic circuit to achieve the functions of the control unit 711.

The electronic circuit 780 is specifically, a single circuit, a composite circuit, a programmed processor, a parallelly programmed processor, a logic IC (Integrated Circuit), a GA (Gate Array), an ASIC, or an FPGA.

The functions of the control unit 711 may be achieved by one electronic circuit or may be achieved by being distributed among a plurality of electronic circuits.

As another modification, part of the functions of the control unit 711 may be achieved by the electronic circuit 780 and the remaining functions may be achieved by software.

The processor 710, the electronic circuit 780, the main storage device 720, and the auxiliary storage device 730 may be collectively referred to as processing circuitry. That is, in the ground installation 90, the functions of the control unit 711 are achieved by the processing circuitry.

The configuration of the ground installation 90 according to another embodiment may also be equivalent to that of the present modification.

### Embodiment 2

In the following, differences from the embodiment described above are mainly described with reference to the drawings.

### Description of Configuration

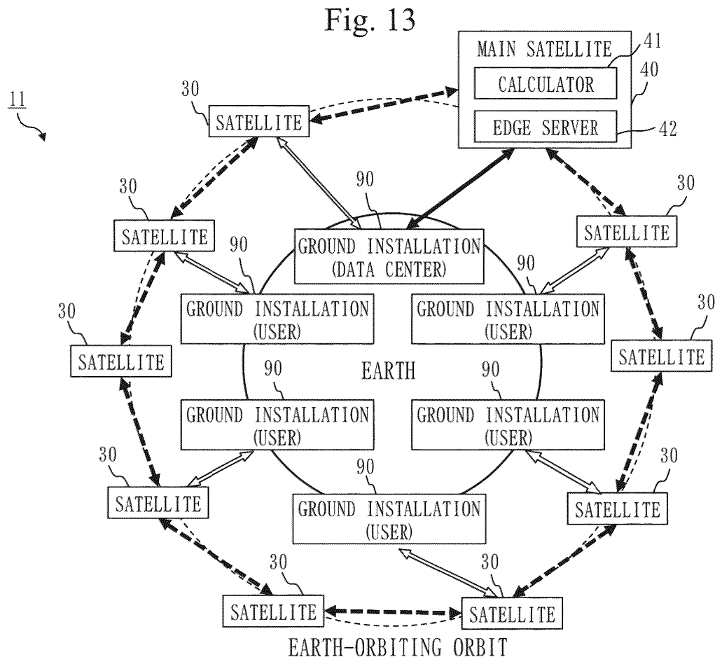

FIG. 13 illustrates a configuration example of an edge computing system 11 according to the present embodiment. The edge computing system 11 is formed of a plurality of satellites 30 flying on a target orbit plane, and includes a main satellite 40. The number of main satellites 40 included in the edge computing system 11 may be any. On the target orbit plane, a circular communication network is formed by the satellites 30 and the main satellite 40.

The satellites 30 according to the present embodiment may not include a third communication device.

The configuration of the main satellite 40 is similar to the configuration of the satellite 30 except that a calculator 41 and an edge server 42 are included. The main satellite 40 may achieve the functions the satellite 30 has.

Each of the calculator 41 and the edge server 42 is a computer. The computer may be equivalent to the computer included in the ground installation 90. The calculator 41 and the edge server 42 may be integrally configured as appropriate.

The calculator 41 performs analytical processing based on an instruction from the ground installation 90. Here, the calculator 41 receives data from the ground installation 90 as appropriate. Also, the calculator 41 generates a transmission command, which is a command for communicating result information to the ground installation 90 and a command for a satellite m.

The edge server 42 has stored therein orbit information of the satellites 30 and the main satellite 40.

The ground installation 90 is a ground installation configuring a data center or a ground installation owned by a user. The user is, as a specific example, a customer contracting with the operator of the data center.

### Description of Operation

### Operation Example 1 According to Embodiment 2

In the following, an operation example of the edge computing system 11 is described.

First, the calculator 41 generates result information by performing analytical processing.

Next, based on the orbit information stored in the edge server 42, the calculator 41 selects a satellite passing over the ground installation 90 from the plurality of satellites as a satellite m, and derives a time Tm0 when the satellite m passes over the ground installation 90. Here, the satellites 30 and the main satellite 40 may be collectively referred to as a “satellite”.

Next, the main satellite 40 transmits the result information to the satellite m via the circular communication network.

Next, the satellite m transmits the result information to the ground installation 90 at the time Tm0.

Note in the present operation example that, when transmitting the generated result information to the ground installation 90, the main satellite 40 including the edge server 42 to perform edge computing generates a communication command to the ground installation 90 for a satellite flying on the target orbit plane. Then, the main satellite 40 transmits, via the circular communication network, the generated communication command to the satellite flying on the target orbit plane. Also, even if the ground installation 90 is arranged directly below the target orbit plane, the time when the satellite flying on the target orbit plane passes over each individual ground installation 90 depends on the flying position in the orbit plane. Thus, based on the satellite orbit information stored in the edge server 42, the main satellite 40 derives the time Tm0 when the satellite m passes over each individual ground installation 90, and also generates a communication command.

According to the present operation example, one effect is that, with the main satellite 40 generating a communication command in the orbit, loads conventionally occurring on the ground and regarding command generation, command transmission, creation of a communication operation plan, and supervision control can be reduced in the ground installation 90.

Also, according to the present operation example, the main satellite 40 is regarded as IoT (Internet of Things), and the main satellite 40 includes the calculator 41 and the edge server 42. Furthermore, each satellite 30 can communicate satellite information via the circular communication network with the ground installation 90 configuring a data center. Thus, according to the present operation example, one effect is that each satellite 30 and the ground installation 90 can quickly perform communication with the edge server 42 included in the main satellite 40.

Also, according to the present operation example, the result of the arithmetic process in the orbit can be transmitted directly to the user's ground installation 90. Thus, one effect is that loads on the ground installation 90 including a data center can be reduced.

### Embodiment 3

In the following, differences from the embodiments described above are mainly described with reference to the drawings.

### Description of Configuration

The configuration of the edge computing system 11 according to the present embodiment corresponds to a combination of the communication satellite system 10 according to Embodiment 1 and the edge computing system 11 according to Embodiment 2. That is, the edge computing system 11 is formed of a plurality of orbit planes.

Among the satellites configuring the edge computing system 11 is the main satellite 40. The main satellite 40 may fly on each orbit plane of two or more orbit planes.

The edge server 42 has stored therein orbit information of each satellite 30 and the main satellite 40 configuring the edge computing system 11.

The calculator 41 included in the main satellite 40 generates an instruction command regarding at least one of transmission and reception. Also, by using an inference model having learned a relation between the arrangement of the satellites in the edge computing system 11 and a communication route in communication among the satellites configuring the edge computing system 11 and information indicating the arrangement of the plurality of satellites configuring the edge computing system 11, the calculator 41 may search for a communication route in communication between the main satellite 40 and each satellite including the information collecting device. By using an inference model having learned a relation between information of movable bodies collected by the information collecting device and movement paths of the movable bodies corresponding to the information collected by the information collecting device and target movable body information, the calculator 41 may predict a movement path of a target movable body. Here, the information collecting device is a device that collects information outside the satellites. The target movable body information is information collected by the information collecting device and about the target movable body. The target movable body is a moving movable body.

The main satellite 40 transmits an instruction command to a satellite flying on the orbit plane where the main satellite 40 is flying and passing in proximity to a point of intersection of the orbit plane and another orbit plane via a circular communication network formed on an orbit plane where the main satellite 40 is flying.

### Description of Operation

### Operation Example 1 According to Embodiment 3

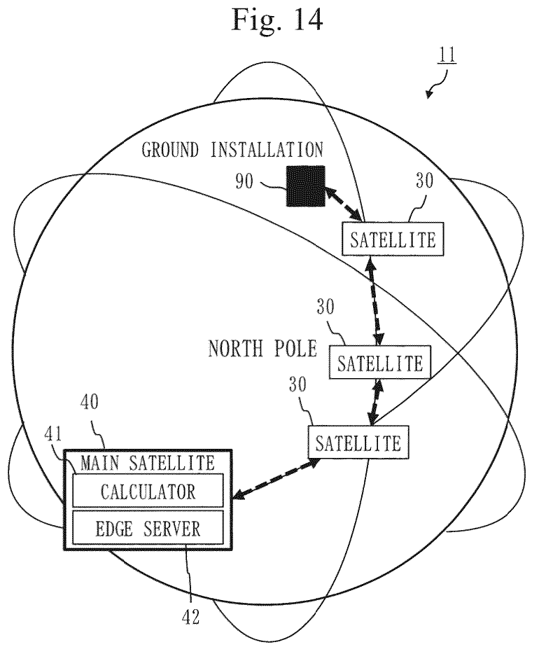

FIG. 14 is a diagram for describing the present operation example. The present operation example is described with reference to FIG. 14.

First, the calculator 41 generates result information by performing analytical processing.

Next, based on the orbit information stored in the edge server 42, the calculator 41 selects, as an overflight orbit plane, an orbit plane passing over the ground installation 90 other than the orbit plane of the main satellite among the plurality of orbit planes. Here, the main satellite orbit plane is an orbit plane where the main satellite 40 including the calculator 41 is flying. Then, the calculator 41 derives an overflight time, which is a time when the overflight orbit plane passes over the ground installation 90. Note that the overflight time may be a timeframe.

Next, the calculator 41 derives a position of a target point of intersection, which is a point of intersection formed in plan view by the main satellite orbit plane and the overflight orbit plane, based on the orbit information stored in the edge server 42.

Next, the main satellite 40 shares the result information with another satellite flying on the main satellite orbit plane via the circular communication network formed on the main satellite orbit plane.

Next, a first communication satellite transmits the result information to a second communication satellite in proximity to the target point of intersection. Here, the first communication satellite is any satellite of the plurality of satellites flying on the main satellite orbit plane. The second communication satellite is any satellite of the plurality of satellites flying on the overflight orbit plane.

Next, the second communication satellite transmits, to a third communication satellite, the result information via the circular communication network formed on the overflight orbit plane. Here, the third communication satellite is a satellite flying on the orbit plane and passing over the ground installation at the overflight time. Note that the second communication satellite and the third communication satellite may be the same satellite and, in this case, the second communication satellite does not transmit the result information to the third communication satellite.

Next, the third communication satellite transmits the result information to the ground installation 90 at the overflight time.

In the present operation example, the rotation of the orbit plane about the earth is not synchronized with the Earth's rotation. Thus, the time when a satellite on a specific orbit plane passes over a specific ground installation 90 is limited. To address this, by providing a plurality of orbit planes with distributed components of normal vectors in the longitudinal direction to increase the orbit planes passing over any ground installation 90, the time when any ground installation 90 can communicate with any satellite increases.

If the edge computing system 11 includes a sufficient number of orbit planes and a sufficient number of satellites so that any ground installation 90 can communicate with any satellite on any orbit plane any time, a permanent communication environment is constructed. Here, to transmit the result information generated by the main satellite 40 on the specific orbit plane to any ground installation 90, it is only required to be transmitted the result information to a satellite on an orbit plane passing over the ground installation 90 at a specific time and by the satellite passing over the ground installation 90, to be transmitted the result information to the ground installation 90.

### Operation Example 2 According to Embodiment 3

The present operation example corresponds to an operation example obtained by expanding the operation example 1 according to Embodiment 3.

In the present operation example, when the traveling direction of the first communication satellite at the target point of intersection is toward a target direction than the traveling direction of the second communication satellite at the target point of intersection, the first communication satellite transmits the result information to the second communication satellite in proximity to the target point of intersection. The target direction is, as a specific example, the north.

In the edge computing system 11 having the main satellite 40 for each orbit plane, by assigning priority to the orbit plane or assigning priority depending on an orbit relative position, it is required to determine timings of transmitting and receiving the result information and satellites to transmit and receive.

In proximity to two points of intersection formed at an orbit altitude on a line of intersection of two orbit planes each having an orbital inclination angle, a satellite northward-moving from the Southern Hemisphere side to the Northern Hemisphere side and a satellite southward-moving from the Northern Hemisphere side to the Southern Hemisphere side pass. Thus, by way of example, with the satellite northward-moving from the Southern Hemisphere side to the Northern Hemisphere side serving as a transmission side and the satellite southward-moving from the Northern Hemisphere side to the Southern Hemisphere side serving as a reception side, a system with the northward-moving satellite 30 assigned with priority can be constructed. In this case, the traveling direction of the northward-moving satellite is northward more than the traveling direction of the southward-moving satellite. Note that the transmission side and the reception side may be reversed. Also, it is required to note that when satellites flying on both of two orbit planes in proximity to the point of intersection are northward-moving or southward-moving satellites, the orbital inclination angles of the two orbit planes are different from each other.

### Operation Example 3 According to Embodiment 3

The present operation example corresponds to an operation example obtained by expanding any above-described operation example according to Embodiment 3. In the present operation example, each orbit plane of the plurality of orbit planes is set with priority regarding a transmission sequence.

Premises in the present operation example are described. The main satellite 40 is flying on each of an orbit plane α and an orbit plane β, which are orbit planes configuring a plurality of orbit planes. The calculator 41 included in the main satellite 40 flying on the orbit plane α generates result information αR as result information. The calculator 41 included in the main satellite 40 flying on the orbit plane β generates result information βR as result information. Any satellite of the plurality of satellites flying on the orbit plane α transmits the result information αR to any satellite of the plurality of satellites flying on the orbit plane β. Any satellite of the plurality of satellites flying on the orbit plane β transmits the result information βR to any satellite of the plurality of satellites flying on the orbit plane α.

First, operation when the priority set to the orbit plane α is higher than the priority set to the orbit plane β is described. In this case, before any satellite of the plurality of satellites flying on the orbit plane β transmits the result information βR to any satellite of the plurality of satellites flying on the orbit plane α, any satellite of the plurality of satellites flying on the orbit plane α transmits the result information αR to any satellite of the plurality of satellites flying on the orbit plane β.

Next, operation when the priority set to the orbit plane α is lower than the priority set to the orbit plane β is described. In this case, after any satellite of the plurality of satellites flying on the orbit plane β transmits the result information βR to any satellite of the plurality of satellites flying on the orbit plane α, any satellite of the plurality of satellites flying on the orbit plane α transmits the result information αR to any satellite of the plurality of satellites flying on the orbit plane β.

By determining priority of the orbit plane in advance, default priority regarding communication when a satellite passes near the point of intersection of orbit planes is defined. However, the result information generated by the main satellite 40 flying on an orbit plane with relatively low priority may be transmitted via an orbit plane with relatively high priority. Thus, when data is transmitted from a satellite flying on an orbit plane with relatively high priority to a satellite flying on an orbit plane with relatively low priority, it is rational to share a communication procedure between the orbit planes of both satellites.

### Operation Example 4 According to Embodiment 3

The present operation example corresponds to an operation example obtained by expanding any above-described operation example according to Embodiment 3. In the present operation example, when a plurality of main satellites 40 are flying on an orbit plane configuring the edge computing system 11, each main satellite 40 of the plurality of main satellites 40 is set with priority regarding the transmission sequence.

In the edge computing system 11 in which the plurality of main satellites 40 each including at least one of the edge server 42 and the calculator 41 including AI (Artificial Intelligence) are present on the same orbit plane, when each main satellite 40 does not cooperate with each other but communicates with a satellite flying on another orbit plane, this poses a risk of confusion in the communication network. To address this, priority is determined in advance among the main satellites 40 for each orbit plane and, when interorbital communication with a specific orbit plane is redundant among the plurality of main satellites 40, the main satellite 40 with relatively high priority set among the plurality of main satellites 40 performs management including transmission of the result information of another main satellite 40 on the same orbit plane.

With the main satellite 40 with relatively high priority set thereto performing the above-described process, one effect is that confusion in the communication network can be avoided.

### Operation Example 5 According to Embodiment 3

The present operation example corresponds to an operation example obtained by expanding any above-described operation example according to Embodiment 3.

In the present operation example, any satellite configuring the edge computing system 11 includes an information collecting device. Here, as the information collecting device included in the satellite, an image information collecting device, a radio information collecting device, or a space environment monitor information collecting device is available. As the image information collecting device, an optical surveillance device for obtaining a visible image, a synthetic aperture radar for obtaining a radio image, or an infrared surveillance device for visualizing temperature information is available.

### Operation Example 6 According to Embodiment 3

The present operation example corresponds to an operation example obtained by expanding the operation example 5 according to Embodiment 3.

In the present operation example, two or more satellites configuring the edge computing system 11 each includes an information collecting device.

The edge server 42 has a flying path model stored therein. The flying path model is used to estimate a flying path of a flying object as a movable body. The flying path of the flying object corresponds to a movement path of the movable body.

The information collecting device is an infrared surveillance device, and also generates flying object detection information. The flying object detection information indicates the result of detecting a flying object.

With communication via the circular communication network formed on each of the plurality of orbit planes and communication in proximity to a point of intersection formed in plan view by two orbit planes different from each other among the plurality of orbit planes, each satellite including the information collecting device shares the flying object detection information with each satellite including the information collecting device and the main satellite 40.

The calculator 41 predicts a flying path of the flying object by using the flying object detection information and the flying path model stored in the edge server 42 and generates an information obtainment command. The information obtainment command is a command to a satellite including the information collecting device and for making an instruction for obtaining information of the flying object.

With communication via the circular communication network formed on each orbit plane of the plurality of orbit planes and communication in proximity to a point of intersection formed in plan view by two orbit planes different from each other among the plurality of orbit planes, the main satellite 40 transmits the information obtainment command to each satellite including the information collecting device.

The edge computing system 11 may perform the above-described process of the present operation example by using machine learning. In the following, machine learning is described.

Machine learning is classified into supervised learning optimized with an input of a teacher signal (correct answer) and unsupervised learning without requiring a teacher signal.

As a specific example, by causing the type of flying object, the type of propellant, and flying models of a plurality of typical patterns to be learned in advance as teacher model to generate an inference model, an inference using actual measurement data of the flying object whose launch is detected by the information collecting device and whose orbit information is obtained becomes relatively easy and quick. Here, by using the inference model, the calculator 41 performs prediction of a flying path of the flying object and estimation of a touchdown position of the flying object.

However, to predict a flying path of the flying object with its flying direction unknown at a stage of detecting a launch, it is required to perform tracking and surveillance of the flying object by a subsequent surveillance satellite. Here, the surveillance satellite is a satellite including the information collecting device. Thus, to transmit launch detection information to the subsequent surveillance satellite, the launch detection information is required to be via a communication network formed of a communication satellite group. Here, in a communication network by a communication satellite constellation, the flying position of a communication satellite momentarily changes. Thus, the surveillance satellite is required to search for an optimum communication route to determine the ID (Identification) of a communication satellite for giving and receiving flying object information and a time when the launch detection information is to be transmitted and received. The same goes for giving and receiving flying object information between the surveillance satellite and the communication satellite. Note that the surveillance satellite may have a function of the communication satellite.

When a search for an optimum communication route is made by the ground installation 90, it is required to make command transmission of information indicating each of the time when the flying object information is to be given and received and the satellite ID to each of the surveillance satellite and the communication satellite. However, in this case, a communication network for command transmission poses a problem.

To address this, it is rational that the main satellite 40 includes an analyzing device by machine learning, searches for an optimum communication route in the orbit, generates a communication command, and transmits the generated communication command to each satellite configuring the searched optimum communication route. Typically, the analyzing device is the calculator 41.

As a scheme of searching for an optimum communication route, a scheme using the algorithm known as Dijkstra's method is effective. Note that in static Dijkstra's method, the weight of each route does not change. However, in a communication network formed of a communication satellite constellation, the weight of each communication route changes with a change of the flying position of the communication satellite, that is, the weight of each communication route changes in accordance with the time change. Thus, for each individual communication satellite searching for an optimum communication route as updating the orbit information, operation may be repeated in which a communication satellite receiving the flying object information searches for an optimum communication route and transmits the flying object information to the next communication satellite. That is, each satellite 30 may include the calculator 41. Also, based on the previously searched optimum communication route and the arrangement of the satellites at a time point of searching for the optimum communication route, the calculator 41 may generate an inference model for inferring an optimum communication route, with information indicating a satellite at the starting point of communication and a satellite at the ending point thereof and information indicating the arrangement of the satellites in the edge computing system 11 as inputs.

Also, in route search, breadth-first search and depth-first search have been known. For the launch detection information, it is prioritized to quickly transmit the flying object information to the communication network with a breadth-first search, and tracking is repeated in the subsequent satellite. However, at a stage where the flying direction of the flying object can be broadly estimated, it is rational to make a depth-first search.

In a flying object tracking system, tracking and surveillance of a flying object are performed as prediction of a flying path by machine learning and search for a communication route by Dijkstra's method, which are described above, are repeated, and an inference of a final touchdown position of the flying object is made.

Furthermore, as a specific example, after repeating tracking and surveillance of the flying object, the calculator 41 generates an inference model by performing machine learning with the use of the actual results of previous tracking and surveillance of flying objects and also by performing deep learning with the use of operation cases of flying object irrelevant to a plurality of flying object models used as teacher models. Here, the actual results of tracking and surveillance of flying objects are formed of the information collected by the information collecting device and information indicating flying paths of the flying objects. With this, in prediction of a flying path of a flying object, an improvement in prediction accuracy and quick prediction can be achieved.

Note that the flying direction and flying distance of a flying object launched not from a fixed launcher but from a transporter erector launcher (TEL) or the like and the flying direction and flying distance of a flying object indicated by a typical flying model have a difference. Thus, it is effective to correct the orbit model of a flying object by performing deep learning with the use of actual measurement data of the flying object.

According to the present operation example, one effect is that satellite information can be quickly shared among the satellites. Note that the edge computing system 11 according to the present operation example may be configured to transmit information obtained by infrared surveillance in the orbit by edge computing to track a flying object called an ultrasonic glider bomb to another satellite including an infrared surveillance device.

### Operation Example 7 According to Embodiment 3

The present operation example corresponds to an operation example obtained by expanding the operation example 5 or 6 according to Embodiment 3.

In the present operation example, the information collecting device is a synthetic aperture radar or an optical surveillance device, and has a function of performing tracking and surveillance of a movable body. The movable body is, as a specific example, a ship.

According to the present operation example, in a case in which a ship sailing across the ocean is tracked by using a synthetic aperture radar or an optical surveillance device, one effect is that the ship can be tracked quickly with a low risk of losing sight of the ship by sharing surveillance information among orbits different from one another.

### Other Embodiments

Free combinations of the above-described embodiments, modification of any component of each embodiment, or omission of any component in each embodiment can be made.

Also, embodiments are not limited to those described in Embodiments 1 to 3, and various changes can be made as required. The procedures described by using drawings and so forth may be changed as appropriate.

### REFERENCE SIGNS LIST

10: communication satellite system; 11: edge computing system; 20: satellite constellation; 30: satellite; 31: satellite control device; 32: communication device; 33: propulsion device; 34: attitude control device; 35: power supply device; 40: main satellite; 41: calculator; 42: edge server; 90: ground installation; 91: satellite control device; 710: processor; 711: control unit; 720: main storage device; 730: auxiliary storage device; 740: input interface; 750: output interface; 760: communication interface; 770: signal line; 780: electronic circuit; 810: ground-side communication device.

1. A communication satellite system formed of a plurality of orbit planes, wherein
azimuth components of normal vectors with respect to each orbit plane of the plurality of orbit planes are distributed to a longitudinal direction,
each orbit plane of the plurality of orbit planes is taken as a target orbit plane, the target orbit plane is an orbit plane corresponding to an inclined orbit, and a plurality of satellites are flying on the target orbit plane,
each satellite flying on the target orbit plane is taken as a target satellite, and the target satellite includes a first communication device to communicate with satellites flying on an orbit plane where the target satellite is flying and positioned at front and rear with respect to a traveling direction of the target satellite, a second communication device to communicate with a ground installation set on ground, and a third communication device to communicate, in proximity to a point of intersection formed in plan view by the orbit plane where the target satellite is flying and another orbit plane, which is an orbit plane different from the orbit plane where the target satellite is flying, with a satellite flying on the another orbit plane, and
on the target orbit plane, the plurality of satellites flying on the target orbit plane form a circular communication network.

2. The communication satellite system according to claim 1, wherein
a first receiving satellite, which is a satellite flying on a first orbit plane, which is an orbit plane passing over a first ground installation and is any orbit plane configuring the plurality of orbit planes, receives communication data, which is data transmitted by the first ground installation, over the first ground installation,
the first receiving satellite shares the communication data with another satellite flying on the first orbit plane via a circular communication network formed on the first orbit plane,
in proximity to a point of intersection formed in plan view by the first orbit plane and a second orbit plane, which is an orbit plane passing over a second ground installation and is any orbit plane configuring the plurality of orbit planes except the first orbit plane, any satellite of the plurality of satellites flying on the first orbit plane transmits the communication data to a second receiving satellite, which is a satellite flying on the second orbit plane,
the second receiving satellite shares the communication data with another satellite flying on the second orbit plane via a circular communication network formed on the second orbit plane, and
any satellite of the plurality of satellites flying on the second orbit plane transmits the communication data to the second ground installation over the second ground installation.

3. The communication satellite system according to claim 1, wherein
a total number of orbit planes configuring the plurality of orbit planes is twelve or more, and a total number of satellites flying on the target orbit plane is fifteen or more.

4. An edge computing system formed of a plurality of satellites flying on a target orbit plane, wherein
each satellite of the plurality of satellites is taken as a target satellite, and the target satellite includes a first communication device to communicate with satellites flying on the target orbit plane and positioned at front and rear with respect to a traveling direction of the target satellite and a second communication device to communicate with a ground installation set on ground,
the plurality of satellites form a circular communication network,
any satellite configuring the plurality of satellites is a main satellite including a calculator and an edge server having orbit information of each satellite of the plurality of satellites stored therein,
the calculator
generates result information by performing analytical processing, and
based on the orbit information stored in the edge server, selects a satellite passing over the ground installation from among the plurality of satellites as a satellite m and derives a time Tm0 when the satellite m passes over the ground installation,
the main satellite transmits the result information to the satellite m via the circular communication network, and
the satellite m transmits the result information to the ground installation at the time Tm0.

5. An edge computing system formed of a plurality of orbit planes, wherein
azimuth components of normal vectors with respect to each orbit plane of the plurality of orbit planes are distributed to a longitudinal direction,
each orbit plane of the plurality of orbit planes is taken as a target orbit plane, the target orbit plane is an orbit plane corresponding to an inclined orbit, and a plurality of satellites are flying on the target orbit plane,
each satellite flying on the target orbit plane is taken as a target satellite, and the target satellite includes a first communication device to communicate with satellites flying on an orbit plane where the target satellite is flying and positioned at front and rear with respect to a traveling direction of the target satellite, a second communication device to communicate with a ground installation set on ground, and a third communication device to communicate, in proximity to a point of intersection formed in plan view by the orbit plane where the target satellite is flying and another orbit plane, which is an orbit plane different from the orbit plane where the target satellite is flying, with a satellite flying on the another orbit plane,
on the target orbit plane, the plurality of satellites flying on the target orbit plane form a circular communication network,
among satellites configuring the edge computing system is a main satellite including a calculator and an edge server having stored therein orbit information of each satellite configuring the edge computing system,
the calculator
generates result information by performing analytical processing, and
based on the orbit information stored in the edge server, selects an orbit plane passing over the ground installation from among the plurality of orbit planes except a main satellite orbit plane, which is an orbit plane where the main satellite including the calculator is flying, as an overflight orbit plane and derives an overflight time, which is a time when the overflight orbit plane passes over the ground installation, and
derives a position of a target point of intersection, which is a point of intersection formed in plan view by the main satellite orbit plane and the overflight orbit plane, based on the orbit information stored in the edge server,
the main satellite shares the result information with another satellite flying on the main satellite orbit plane via a circular communication network formed on the main satellite orbit plane,
in proximity to the target point of intersection, a first communication satellite, which is any satellite of the plurality of satellites flying on the main satellite orbit plane, transmits the result information to a second communication satellite, which is any satellite of the plurality of satellites flying on the overflight orbit plane,
the second communication satellite transmits the result information to a third communication satellite, which is a satellite flying on the overflight orbit plane and passing over the ground installation at the overflight time, via a circular communication network formed on the overflight orbit plane, and
the third communication satellite transmits the result information to the ground installation at the overflight time.

6. The edge computing system according to claim 5, wherein
when a traveling direction of the first communication satellite at the target point of intersection is toward a target direction than a traveling direction of the second communication satellite at the target point of intersection, the first communication satellite transmits the result information to the second communication satellite in proximity to the target point of intersection.

7. The edge computing system according to claim 5, wherein
each orbit plane of the plurality of orbit planes is set with priority regarding a transmission sequence,
when the main satellite is flying on each of an orbit plane α and an orbit plane β, which are orbit planes configuring the plurality of orbit planes, the calculator included in the main satellite flying on the orbit plane α generates result information αR as the result information, the calculator included in the main satellite flying on the orbit plane β generates result information βR as the result information, any satellite of the plurality of satellites flying on the orbit plane α transmits the result information αR to any satellite of the plurality of satellites flying on the orbit plane β, and any satellite of the plurality of satellites flying on the orbit plane β transmits the result information βR to any satellite of the plurality of satellites flying on the orbit plane α,
when priority set to the orbit plane α is higher than priority set to the orbit plane β, before any satellite of the plurality of satellites flying on the orbit plane β transmits the result information βR to any satellite of the plurality of satellites flying on the orbit plane α, any satellite of the plurality of satellites flying on the orbit plane α transmits the result information αR to any satellite of the plurality of satellites flying on the orbit plane β, and
when the priority set to the orbit plane α is lower than the priority set to the orbit plane β, after any satellite of the plurality of satellites flying on the orbit plane β transmits the result information βR to any satellite of the plurality of satellites flying on the orbit plane α, any satellite of the plurality of satellites flying on the orbit plane α transmits the result information αR to any satellite of the plurality of satellites flying on the orbit plane β.

8. The edge computing system according to claim 5, wherein
when a plurality of said main satellites are flying on an orbit plane configuring the edge computing system, each main satellite of the plurality of main satellites is set with priority regarding a transmission sequence.

9. The edge computing system according to claim 5, wherein
the calculator included in the main satellite generates an instruction command regarding transmission or reception, and
the main satellite transmits the instruction command to a satellite flying on an orbit plane where the main satellite is flying and passing in proximity to the target point of intersection via a circular communication network formed on an orbit plane where the main satellite is flying.

10. The edge computing system according to claim 5, wherein
any satellite configuring the edge computing system includes an information collecting device to collect information outside the satellites.

11. The edge computing system according to claim 10, wherein
each of two or more satellites configuring the edge computing system includes the information collecting device,
the edge server has a flying path model stored therein,
the information collecting device is an infrared surveillance device, and generates flying object detection information indicating a result of detection of a flying object, which is a movable body,
with communication via the circular communication network formed on each orbit plane of the plurality of orbit planes and communication in proximity to a point of intersection formed in plan view by two orbit planes different from each other among the plurality of orbit planes, each satellite including the information collecting device shares the flying object detection information with another satellite including the information collecting device and the main satellite,
the calculator predicts a flying path of the flying object by using the flying object detection information and the flying path model stored in the edge server and generates an information obtainment command, which is a command to a satellite including the information collecting device and for making an instruction for obtaining information of the flying object, and
with communication via the circular communication network formed on each orbit plane of the plurality of orbit planes and communication in proximity to a point of intersection formed in plan view by two orbit planes different from each other among the plurality of orbit planes, the main satellite transmits the information obtainment command to each satellite including the information collecting device.

12. The edge computing system according to claim 10, wherein
the information collecting device is a synthetic aperture radar or an optical surveillance device, and has a function of performing tracking and surveillance of a movable body.

13. The edge computing system according to claim 11, wherein
by using an inference model having learned a relation between arrangement of the satellites in the edge computing system and a communication route in communication among the satellites configuring the edge computing system and information indicating the arrangement of the plurality of satellites, the calculator searches for a communication route in communication between the main satellite and each satellite including the information collecting device.

14. The edge computing system according to claim 11, wherein
by using an inference model having learned a relation between information of movable bodies collected by the information collecting device and movement paths of the movable bodies corresponding to the information collected by the information collecting device and target movable body information, which is information collected by the information collecting device and about a target movable body, which is a moving movable body, the calculator predicts a movement path of the target movable body.

15. The main satellite according to claim 4.
